(19) United States
(12) Patent Application Publication
(10) Pub. No.: US 2003/0012590 A1
(43) Pub. Date: Jan. 16, 2003

(54) Impact dot printer head and printing apparatus

(75) Inventors: Yasunobu Terao, Tagata-gun (JP); Tetsuro Ichitani, Mishima-shi (JP); Takahiro Kawaguchi, Mishima-shi (JP); Keishi Tsuchiya, Tagata-gun (JP); Takeshi Okui, Mishima-shi (JP); Masayuki Ilnuma, Tagata-gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Toshiba TEC Kabushiki Kaisha, Tokyo (JP)

(21) Appl. No.: 10/186,994

(22) Filed: Jul. 2, 2002

(30) Foreign Application Priority Data
Jul. 2, 2001 (JP) 2001-200440

(51) Int. Cl. B41J 2/22

(52) U.S. Cl. 400/124.01

(57) ABSTRACT

An impact dot printer head having one or plural heat conductive members. The heat conductive member, with a part in the proximity of armature stopper of the impact dot printer head while another part guided to the outside a housing of the impact dot printer head, conducts heat inside the housing to the outside. Accordingly, as the heat conductive member first conducts heat of the armature stopper to a heat radiation unit outside the housing, degradation of hardness of the armature stopper due to heat can be prevented, and a return position of the armature can be determined in a stable manner.

### CROSS REFERENCE TO RELATED APPLICATION

The present application is based on Japanese Priority Document 2001-200440 filed on Jul. 2, 2001.

### BACKGROUND OF THE INVENTION

1. Field of the Invention

The present invention relates to an impact dot printer head and a printing apparatus having the impact dot printer head.

2. Description of the Background

An impact dot printer head is known as a printer head which has plural armatures, with plural coils attached to cores magnetically connected to a yoke to drive wires at one ends, risably supported to be opposite to end surfaces of the cores. The impact dot printer head performs printing by driving the armatures by selectively energizing the coils, and displacing the wires in a printing direction by the operations of the armatures. In the impact dot printer head, when energization to the coil is cut, the armature is returned in an opposite direction to the printing direction by a biasing force of biasing member, and upon returning of the armature, the armature is brought into contact with an armature stopper thereby a return position is defined.

In the impact dot printer head, as the temperature rises due to energization to the coils, the coils are broken when the temperature exceeds a thermal resistance allowable range. Accordingly, measures must be taken against heat; for example, the heat is radiated from a housing of the impact dot printer head, or from a carrier with which a metal part on the surface of the impact dot printer head is brought into contact. Japanese Published Unexamined Patent Application No. Hei 6-8590 proposes heat radiation by conduction of heat at the internal center of impact dot printer head to a heat sink by a thermal conductive pipe or the like.

Further, upon printing by using the impact dot printer head, frequency of use of the respective wires of the impact dot printer head is not uniform but some wires are frequently used while the other wires are not so frequently used. As the coils of the frequently-used wires are often energized, the temperature rise often occurs and the coil is easily broken. Accordingly, Japanese Published Examined Patent Application No. Hei 4-49477 proposes providing a temperature sensor to detect the temperature of a coil to drive a frequently used wire and stopping printing by the impact dot printer head when the coil temperature becomes the maximum allowable value.

As the armature stopper is formed with elastic material such as rubber for prevention of rebound of the armature, the hardness of the elastic material is lowered by temperature rise. The degradation of hardness degrades the function of the armature stopper to quickly stabilize the armature to an accurate return position. Further, since there is an increasing need for high-speed printing, the amount of heat generation in the impact dot printer is increasing. For this reason, the number of energization to the coil of frequently-used wire is large and the temperature rises, thus the coil is easily broken.

On the other hand, in the technique disclosed in Japanese Published Examined Patent Application No. Hei 4-49477, as the temperature sensor is provided in which the temperature of coil to drive the frequently-used wire is detected, and printing is stopped when the coil temperature becomes the maximum allowable value, the need for high-speed printing cannot be satisfied. Further, in Japanese Published Unexamined Patent Application No. Hei 6-8590, there is no description about a technique of preventing degradation of armature stopper function and preventing breakage of frequently energized coil.

### SUMMARY OF THE INVENTION

Accordingly, an object of the present invention is to prevent degradation of hardness of an armature stopper in an impact dot printer head due to temperature rise, and to stabilize a return position of armature.

Another object of the present invention is to prevent breakage of frequently energized coil without reducing printing speed of impact dot printer head.

The above objects of the present invention are attained by providing novel impact dot printer head and printing apparatus according to the present invention.

The present invention provides an impact dot printer head having one or plural thermal conductive members. The terminal conductive member, having a part in the proximity of an armature stopper of the impact dot printer head and another part guided to the outside a housing of the impact dot printer head, conducts heat inside the housing to the outside. Accordingly, as the thermal conductive member first conducts the heat of the armature stopper to a heat radiation means outside the housing, degradation of the hardness of the armature stopper due to heat can be prevented, and a return position of the armature can be determined in a stable manner.

According to another aspect of the present invention, provided is an impact dot printer head having one or plural thermal conductive members. The thermal conductive member, having a part in the proximity of one or more of plural coils of the impact dot printer head, of relatively high energization frequency, and another part guided to the outside a housing of the impact dot printer head, conducts heat inside the housing to the outside. Accordingly, the thermal conductive member effectively conducts the heat inside the housing to the outside the housing, and breakage of coil can be prevented without reducing the printing speed.

According to another aspect of the present invention, provided is a printing apparatus where an impact dot printer head has one or more thermal conductive members. The terminal conductive member, having a part in the proximity of an armature stopper of the impact dot printer head and another part guided to the outside a housing of the impact dot printer head, conducts heat inside the housing to the outside. Accordingly, as the thermal conductive member first conducts the heat of the armature stopper to the outside the housing, degradation of the hardness of the armature stopper due to heat can be prevented, and a return position of the armature can be determined in a stable manner.

According to another aspect of the present invention, provided is a printing apparatus where an impact dot printer head has one or plural thermal conductive members. The thermal conductive member, having a part in the proximity of one or more of plural coils of the impact dot printer head, of relatively high energization frequency, and another part guided to the outside a housing of the impact dot printer head, conducts heat inside the housing to the outside. Accordingly, the thermal conductive member effectively conducts the heat inside the housing to the outside the housing, and breakage of coil can be prevented without reducing the printing speed.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The above and other object, features and advantages of the present invention will become more apparent from the following detailed description when taken in conjunction with the accompanying drawings wherein:

FIG. 1 is a longitudinal sectional view of impact dot printer head according to a first embodiment of the present invention;

FIG. 2 is a perspective view of carrier holding the impact dot printer head;

FIG. 3 is a perspective view of the carrier;

FIG. 4 is a longitudinal sectional view of the impact dot printer head according to a second embodiment of the present invention;

FIG. 5 is an explanatory view of array pattern of 9 wire ends;

FIG. 6 is an explanatory view of array pattern of 24 wire ends;

FIG. 7 is an exploded perspective view of the impact dot printer head according to a third embodiment of the present invention;

FIG. 8 is a perspective view of heat pipes and connection pipes to support the heat pipes; and

FIG. 9 is a longitudinal sectional view showing a schematic construction of printing apparatus according to a fourth embodiment of the present invention.

### DETAILED DESCRIPTION OF THE PREFERRED EMBODIMENTS

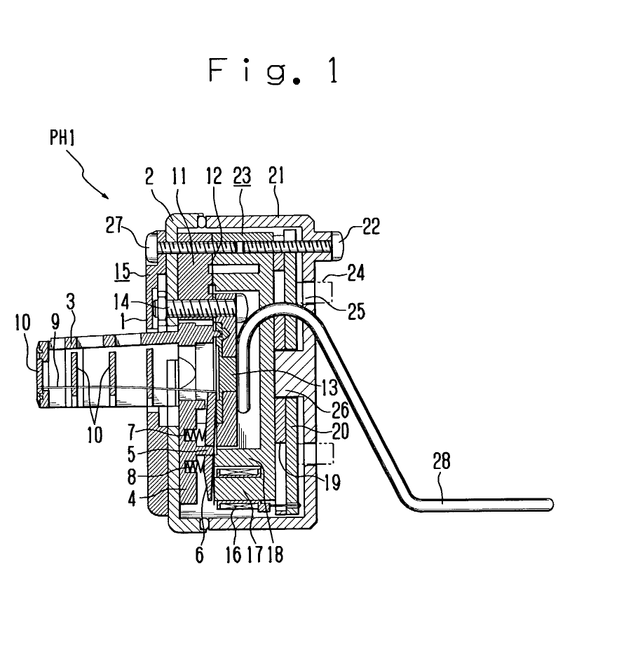

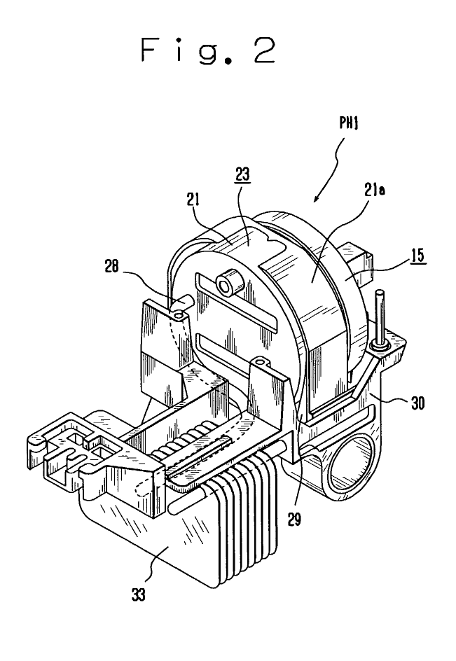

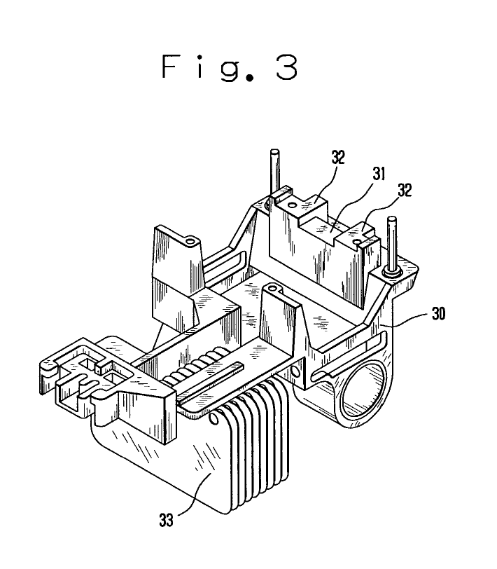

A first embodiment of the present invention will be described with reference to FIGS. 1 to 3. FIG. 1 is a longitudinal sectional view of impact dot printer head, FIG. 2, a perspective view of carrier holding the impact dot printer head, and FIG. 3, a perspective view of the carrier.

First, the structure of impact dot printer head PH1 will be described. The impact dot printer head PH1 has an attachment member 1 fixed to a carrier 30 to be described later, a front surface cover 2 having a shape of one-end open container, and a wire guide 3 projecting from the bottom of the front surface cover 2. An armature guide 4 in contact with the bottom of the front surface cover 2 is integrally formed at the base end side of the wire guide 3. The armature guide 4 is provided with plural guide pins 5 and projection pieces (not shown) to guide the both sides of armature 6. Further, the armature guide 4 is provided with an armature spring 7 as a biasing member which presses the armature 6 in a returning direction opposite to the printing direction, and a support pressing spring 8, on the inner and outer sides of the guide pin 5. Plural wires 9, with their base ends fixed to the distal end of the armature 6, are slidable to plural guide chips 10 fixed to the wire guide 3. Further, cutouts (not shown) are formed in plural positions of outer periphery of the armature guide 4. Plural stopper receivers 11 are engaged in these cutouts. In a status where the wires 9 are inserted through the guide chips 10 and the armature 6 is engaged with the guide pins 5, the bottom surface of the front surface cover 2, the stopper receivers 11, a film 12 of non-magnetic material, and the armature stopper 13 are laminated and coupled by a screw 14, thereby an armature block 15 is constructed.

Plural cores 17, to which coils 16 are respectively attached, are integral with a yoke 18. The yoke 18, a ring-shaped spacer 19, and a substrate 20 to which the coils 16 are electrically connected, and a container-shaped housing 21 are laminated and coupled by plural screws 22, thereby constituting a yoke block 23. The housing 21 is formed of metal material having high thermal conductivity, and has an opening 25 from which a connector 24 for connection between the substrate 20 with an external circuit (not shown) of the impact dot printer head PH1, and a projection 26 in contact with a central portion of the yoke 18 in its bottom.

Plural screws 27 inserted through the attachment member 1, the front surface cover 2, the film 12, and the stopper receivers 11, are screw-engaged with the yoke 18, thereby the armature block 15 and the yoke block 23 are coupled to each other, thus the impact dot printer head PH1 is constructed. In this status, the inner surface of the armature 6 is in contact with a cylindrical edge (support member) of the yoke 18 via the film 12 risably, by pressure of the support pressing spring 8.

As shown in FIG. 2, the yoke block 23 has a heat sink 21a as a heat radiation member surrounding the outer periphery of the housing 21. A heat pipe 28 as a thermal conductive member is inserted through the bottom surface of the housing 21. As shown in FIG. 1, a part of the heat pipe 28 is in the proximity of the armature stopper 13, and desirably, in contact therewith. Further, as shown in FIG. 2, to conduct heat within the housing 21 to the outside, another heat pipe 29 as a thermal conductive member is inserted between the housing 21 and the heat sink 21a.

As these heat pipes 28 and 29 have a pipe structure to circulate working fluid inside, they have very low internal pressure. Accordingly, the working fluid is boiled at a low temperature in heat absorption parts of the heat pipes 28 and 29, and evaporation latent heat is absorbed upon evaporation of the working fluid by the boiling. The evaporated gas comes to heat radiation parts of the heat pipes 28 and 29 at a transonic speed, and the gas is condensed to liquid, and radiates condensation latent heat. The working fluid returns through the pipe structure to the heat absorption parts. The above cycle is repeated, thereby the heat pipes 28 and 29 cool the armature stopper 13.

As shown in FIG. 3, the carrier 30 holding the impact dot printer head PH1 has a support table 31 supporting the wire guide 3 of the impact dot printer head PH1 in the engaged status, and an attachment member 32 provided on the both sides of the table to fix the attachment member 1 by screws (not shown). The carrier 30 has a large number of radiation fins 33 to radiate heat of the heat pipes 28 and 29 so as to improve the function as heat radiation members, and is formed of excellent heat radiative material such as aluminum.

Next, the operation of the impact dot printer head PH1 will be described. When a selected coil 16 is excited, the armature 6 is attracted to an end surface of the core 17, and the wire 9 collides against a print sheet on a platen 54 (to be described later) via an ink ribbon (not shown), thereby printing is performed. When energization to the coil 16 is stopped, the armature 6 returns by the biasing force of the armature spring 7, and the return position is determined by the armature stopper 13.

In this manner, upon execution of printing by the impact dot printer head PH1, the temperatures of the armature stopper 13 and the yoke 18 rise due to heat generation of the coil 16. The heat of the armature stopper 13 is conducted by the heat pipe 28 in contact with the stopper to the carrier 30. Further, the heat conducted from the coil 16 to the attachment member 1, the wire guide 3 and the like is conducted from the support table 31 to the entire carrier 30. Further, heat conducted to the housing 21 is conducted to the heat sink 21a and the carrier 30 via the heat pipe 29. As the carrier 30 is formed of excellent heat radiative metal material such as aluminum and further has a large number of radiation fins 33, the heat conducted to the carrier 30 can be quickly radiated.

Note that in a case where the amount of heat generation in the impact dot printer head PH1 is large and the amount of heat absorption by the heat pipe 28 is saturated, one or more heat pipes 29 are added as described above, depending on the amount of heat generation. In a case where the heat in the impact dot printer head PH1 can be treated by one heat pipe, only the heat pipe 28 is used, and the heat of the armature stopper 13 among the constituent elements of the impact dot printer head PH1 is first radiated by the heat pipe 28. In this case, the heat pipe 29 shown in FIG. 2 is omitted.

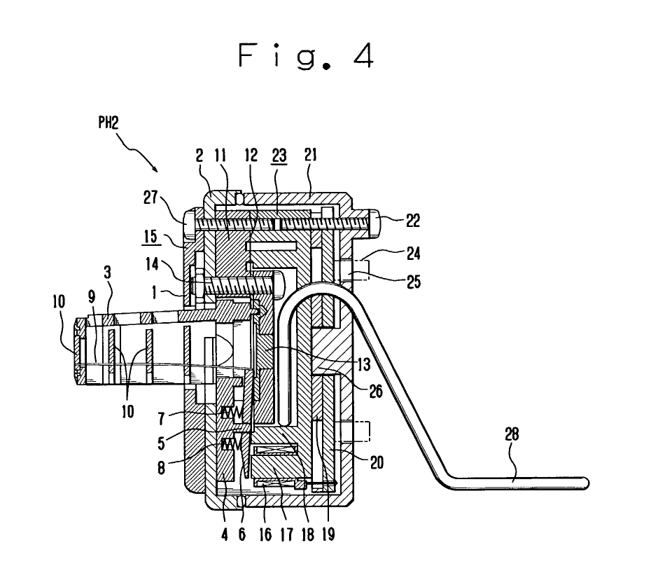

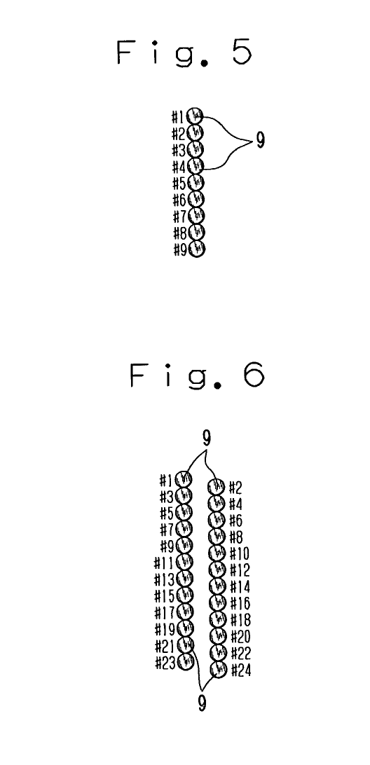

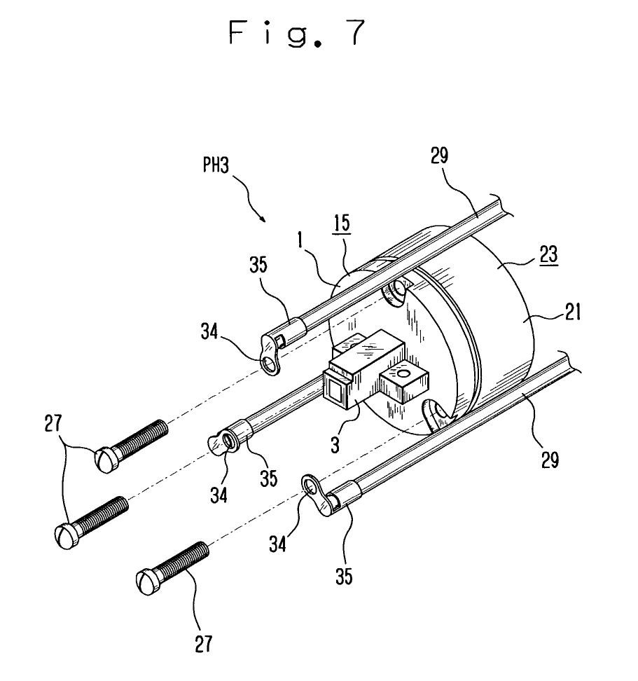

Next, a second embodiment of the present invention will be described with reference to FIGS. 4 to 6. Note that the same elements as those of the first embodiment have the same reference numerals and explanations thereof will be omitted. FIG. 4 is a longitudinal sectional view of the impact dot printer head according to a second embodiment of the present invention, FIG. 5 is an explanatory view of array pattern of 9 wire ends, and FIG. 6 is an explanatory view of array pattern of 24 wire ends. In the present embodiment, an impact dot printer head PH2 differs from the impact dot printer head PH1 of the first embodiment in that the heat pipe 28 is in the proximity of the coil 16 of the highest frequency of energization. More particularly, the heat pipe 28 is in contact with a member closest to the most-frequently energized coil 16 among the respective parts of the yoke 18.

Accordingly, the heat in a part, where the temperature becomes the highest among the respective parts of the yoke 18, is quickly conducted to the carrier 30 by the heat pipe 28 and is radiated from the carrier 30. In a case where the amount of heat generation in the impact dot printer head PH2 is large and the amount of heat absorption by the heat pipe 28 is saturated, one or more heat pipes 28 must be added. In this case, the coil 16 of the second or lower highest energization frequency is sequentially selected in descending order, and the additional heat pipe 28 is set in contact with a part of the yoke 18 closest to the selected coil 16.

In this manner, breakage of the frequently energized coils can be prevented. Note that in ASCII draft printing by using 9 wires 9 (9-pin type), the most frequency energized coil 16 is a coil to drive the 7th (#7) wire 9 as shown in FIG. 5, and in case of ASCII-LQ (letter quality) printing by using 24 wires (24-pin type), the most frequency energized coil 16 is a coil to drive the 20th (#20) wire 9 as shown in FIG. 6. In this manner, in the impact dot printer head PH2, the frequently used coil 16 differs in accordance with character font upon printing. Accordingly, in the impact dot printer head PH2, the heat pipe 28 is brought into contact with the frequently used coil 16 regarding the most frequently used font. In this case, when plural heat pipes 28 are used, it is preferable that the coils 16 are selected sequentially from the highest frequency of use in correspondence with the number of the heat pipes 28, and the respective heat pipes 28 are brought into contact with the selected coils 16.

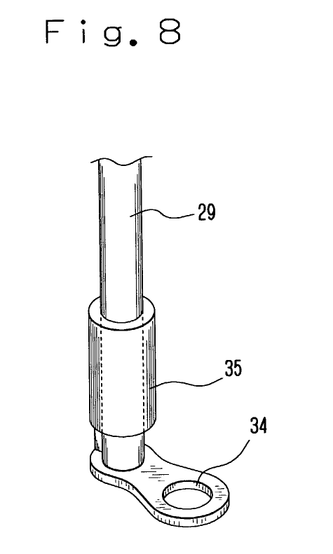

Next, a third embodiment of the present invention will be described with reference to FIGS. 7 and 8. Note that the same elements as those of the first and second embodiments have the same reference numerals and explanations thereof will be omitted. FIG. 7 is an exploded perspective view of the impact dot printer head according to the third embodiment of the present invention, and FIG. 8, a perspective view of the heat pipes and connection pipes to support the heat pipes. In the third embodiment, an impact dot printer head PH3 is characterized in that the heat pipe 29 is removably attached, and the structure of the impact dot printer head PH3 except an attachment structure of the heat pipe is the same as that of the impact dot printer heads PH1 and PH2 of the first and second embodiment.

That is, plural connection pipes 35 having an attachment hole 34 are prepared, and when the armature block 15 and the yoke block 23 are coupled to each other by the screws 27, the screws 27 are inserted through the attachment holes 34, thereby the connection pipes 35 are fixed to the attachment member 1. Then ends of the heat pipes 29 are inserted into the connection pipes 35. These heat pipes 29 are brought in contact with the outer peripheral surface of the housing 21, and as in the case of the above-described embodiments, distal ends thereof are in contact with the radiation fins 33 of the carrier 30.

Accordingly, the heat of the attachment member 1 and the housing 21 can be quickly conducted to the carrier 30 by the heat pipes 29 and radiated from the carrier 30. Further, in a case where the impact dot printer head PH3 comes to the end of its life after a long term use, the heat pipes 29 are pulled out of the connection pipes 35, or the screws 27 are loosen and the heat pipes 29 with the connection pipes 35 are removed, thereby the expensive heat pipes 29 can be reused as constituent elements of a new impact dot printer head PH3.

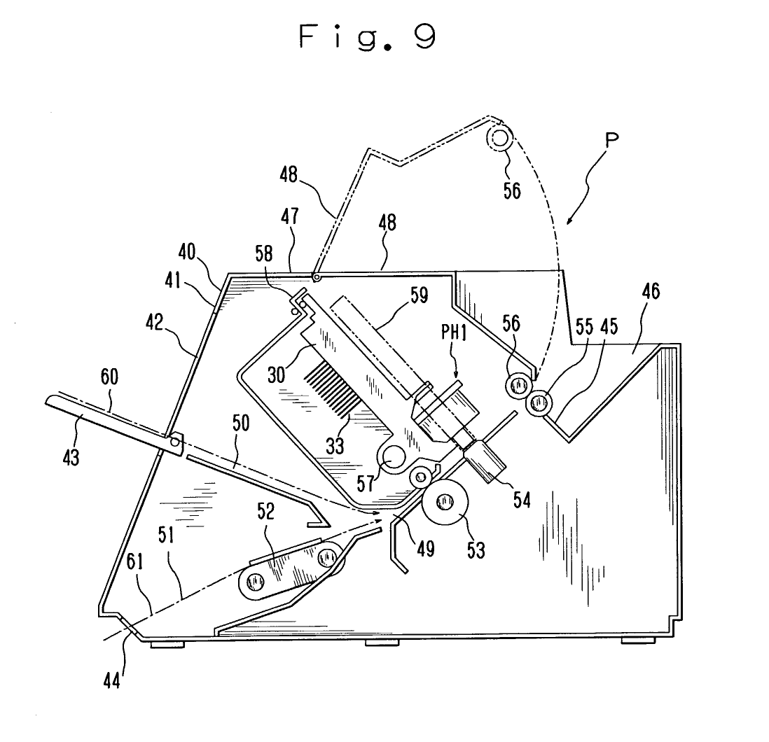

Next, a fourth embodiment of the present invention will be described with reference to FIG. 9. FIG. 9 is a longitudinal sectional view showing a schematic construction of printing apparatus (serial printer) P. In the printing apparatus P, an opening 42 is formed in a front surface 41 of a printer main body 40. A manual-feed tray 43 is openably/closably provided in the opening 42. Further, a paper feed port 44 is formed in a lower part on the front surface 41 side of the printer main body 40, and a paper discharge receiver 46 is provided on the rear surface 45 side. Further, an opening/closing cover 48 is rotatably supported on an upper surface 47 of the printer main body 40.

A paper conveyance path 49 is provided at a central part of the printer main body 40. An upstream side of the paper conveyance passage 49 is connected to a paper feed passage 50 provided on a plane extended from the manual-feed tray 43 in open status and a paper feed path 51 communicating with the paper feed port 44, and a downstream side is connected to the paper discharge receiver 46. The paper feed pass 51 is provided with a tractor 52. The paper conveyance path 49 is provided with a pair of conveyance rollers 53 and a platen 54. A paper discharge roller 55 is provided at the entrance of the paper discharge receiver 46. A pressing roller 56, in press-contact with the paper discharger roller 55, is rotatably supported on the free end side of the opening/closing cover 48.

The above-described carrier 30 is slidably supported by a carrier shaft 57 and a guide rail 58 parallel to an axis of the conveyance rollers 53. The above-described impact dot printer head PH1 (or impact dot printer head PH2 or PH3) is mounted on the carrier 30. Further, an ink ribbon cassette 59 is removably supported in the carrier 30.

Next, the operation of the printing apparatus P will be described. If a single sheet 60 is used as the print sheet, it is fed from the manual-feed tray 43, and if a continuous sheet 61 is used as the print sheet, it is fed from the paper feed port 44. In use of any print sheet, the print sheet is conveyed by the conveyance rollers 53, printing is performed on the sheet by the impact dot printer head PH1, and the sheet is discharged by the paper discharge rollers 55 and 56 to the paper discharge receiver 46.

In this example, as the carrier 30 is tilted at an angle of approximately 45 to a horizontal direction such that the wires 9 of the impact dot printer head PH1 collide against the sheet (not shown) in a downward direction, the heat pipes 28 and 9 (See FIGS. 1 and 2) are also tilted such that the impact dot printer head PH1 side is lower.

Accordingly, the working fluid is boiled at a low temperature in the heat absorption parts (parts on the impact dot printer head PH1 side) of the heat pipes 28 and 29, the gas evaporated from the working fluid by the boiling comes to the radiation part (radiation fins 33 or the like). When the working fluid liquefied by radiation of condensation latent heat returns to the heat absorption part on the impact dot printer head PH1 side, the working fluid can be quickly returned along a gravity acting direction. By this operation, the cycle of heat radiation of the impact dot printer head PH1 can be quickened. In a case where the carrier 30 is placed in the horizontal direction, if the heat pipes 28 and 29 are titled in the direction where the impact dot printer head PH1 side is lower, the heat radiation cycle can be quickened by a similar operation. In this manner, it is preferable that the impact dot printer head PH1 is set such that the impact dot printer head PH1 side of the heat pipes 28 and 29 is lower than the other end.

Note that while this invention has been described in connection with the above-described embodiments, various changes and modifications can be made. Accordingly, it is to be understood that all alternative, modification and equivalents can be included within the spirit and scope of the following claims.

What is claimed is:

1. An impact dot printer head comprising:
a yoke provided inside a housing;
plural cores magnetically connected to the yoke;
plural armatures risably supported in positions respectively opposite to the cores;
plural wires driven in a printing direction by rising operation of the armatures;
plural coils supported by the cores and driving the armatures in the printing direction by energization;
a biasing member that presses the armatures in a returning direction opposite to the printing direction;
an armature stopper formed of elastic material and receiving a rear end of the armature or the wire to determine a return position of the wire; and
one or plural heat conductive members, with a part in the proximity of the armature stopper while another part guided to outside the housing, that conduct heat inside the housing to the outside.

2. An impact dot printer head comprising:
a yoke provided inside a housing;
plural cores magnetically connected to the yoke;
plural armatures risably supported in positions respectively opposite to the cores;
plural wires driven in a printing direction by rising operation of the armatures;
plural coils supported by the cores and driving the armatures in the printing direction by energization;
a biasing member that presses the armatures in a returning direction opposite to the printing direction;
an armature stopper formed of elastic material and receiving a rear end of the armature or the wire to determine a return position of the wire; and
one or plural heat conductive members, with a part in the proximity of one or plural coils of relatively high energization frequency while another part guided to outside the housing, that conduct heat inside the housing to the outside.

3. The impact dot printer head according to claim 1, wherein the heat conductive member is a heat pipe.

4. The impact dot printer head according to claim 2, wherein the heat conductive member is a heat pipe.

5. The impact dot printer head according to claim 2, wherein the printer head is a 9-pin type head, and wherein the heat conductive member has a part in the proximity of the coil to drive a #7 wire.

6. The impact dot printer head according to claim 2, wherein the printer head is a 24-pin type head, and wherein the heat conductive member has a part in the proximity of the coil to drive a #20 wire.

7. The impact dot printer head according to claim 1, wherein the heat pipe is removable to the impact dot printer head.

8. The impact dot printer head according to claim 2, wherein the heat pipe is removable to the impact dot printer head.

9. A printing apparatus comprising:
a platen provided in a medium conveyance path for conveyance of a printing medium;
an impact dot printer head; and
a carrier that is scan-driven in a linear direction while supporting the impact dot printer head,
wherein the impact dot printer head comprising:
a yoke provided inside a housing;
plural cores magnetically connected to the yoke;
plural armatures risably supported in positions respectively opposite to the cores;
plural wires driven in a printing direction by rising operation of the armatures;
plural coils supported by the cores and driving the armatures in the printing direction by energization;
a biasing member that presses the armatures in a returning direction opposite to the printing direction;
an armature stopper formed of elastic material and receiving a rear end of the armature or the wire to determine a return position of the wire; and
one or plural heat conductive members, with a part in the proximity of the armature stopper while another part guided to outside the housing, that conduct heat inside the housing to the outside.

10. A printing apparatus comprising:
a platen provided in a medium conveyance path for conveyance of a printing medium;
an impact dot printer head; and
a carrier that is scan-driven in a linear direction while supporting the impact dot printer head,
wherein the impact dot printer head comprising:
a yoke provided inside a housing;
plural cores magnetically connected to the yoke;
plural armatures risably supported in positions respectively opposite to the cores;
plural wires driven in a printing direction by rising operation of the armatures;
plural coils supported by the cores and driving the armatures in the printing direction by energization;
a biasing member that presses the armatures in a returning direction opposite to the printing direction;
an armature stopper formed of elastic material and receiving a rear end of the armature or the wire to determine a return position of the wire; and
one or plural heat conductive members, with a part in the proximity of one or plural coils of relatively high energization frequency while another part guided to outside the housing, that conduct heat inside the housing to the outside.

11. The printing apparatus according to claim 9, wherein the heat conductive member is a heat pipe.

12. The printing apparatus according to claim 10, wherein the heat conductive member is a heat pipe.

13. The printing apparatus according to claim 9, wherein the heat conductive member is a heat pipe provided such that the impact dot printer head side is lower than the other end.

14. The printing apparatus according to claim 10, wherein the heat conductive member is a heat pipe provided such that the impact dot printer head side is lower than the other end.

15. The printing apparatus according to claim 9, wherein the heat conductive member conducts the heat inside the housing to the carrier.

16. The printing apparatus according to claim 10, wherein the heat conductive member conducts the heat inside the housing to the carrier.

17. The printing apparatus according to claim 9, wherein the heat conductive member conducts the heat inside the housing to the carrier, and wherein the carrier has radiation fins that radiate heat of the heat conductive member.

18. The printing apparatus according to claim 10, wherein the heat conductive member conducts the heat inside the housing to the carrier, and wherein the carrier has radiation fins that radiate heat of the heat conductive member.

19. The printing apparatus according to claim 9, wherein the heat conductive member conducts the heat inside the housing to the carrier, and wherein the carrier is formed of aluminum.

20. The printing apparatus according to claim 10, wherein the heat conductive member conducts the heat inside the housing to the carrier, and wherein the carrier is formed of aluminum.
